(19) United States
(12) Patent Application Publication
(10) Pub. No.: US 2023/0317319 A1
(43) Pub. Date: Oct. 5, 2023

(54) METHOD FOR PRODUCING AN ELECTRICAL CONTACT ASSEMBLY AND ELECTRICAL CONTACT ASSEMBLY

(71) Applicant: Siemens Aktiengesellschaft, München (DE)

(72) Inventors: Michael Aicher, Amberg (DE); Andreas Eismann, Hirschaid (DE)

(21) Appl. No.: 18/191,968

(22) Filed: Mar. 29, 2023

(30) Foreign Application Priority Data
Apr. 5, 2022 (DE) 10 2022 203 351.5

(51) Int. Cl. H01B 13/00; H01B 5/00; H01R 4/02; H01R 4/06; H01R 43/02; H01R 43/04

(52) U.S. Cl. CPC H01B 13/0016; H01B 5/00; H01R 4/029; H01R 4/06; H01R 43/0214; H01R 43/04; H01H 11/06

(57) ABSTRACT

A method for producing an electrical contact assembly includes. Providing a contact carrier of a first conductive material, the contact carrier having at least one depression or an aperture. Furthermore, a contact material support of a second conductive material is provided. This contact material support is pressed in the depression or the aperture while at the same time applying an electrical welding voltage to the contact material support and the contact carrier, a pressing-force/welding-current/time profile being chosen such that the contact carrier and the contact material support form a connection including interlocking and/or frictional engagement and a connection including material bonding in one working step.

### CROSS-REFERENCE TO RELATED APPLICATIONS

This application claims priority to DE Application No. 10 2022 203 351.5, having a filing date of Apr. 5, 2022, the entire contents of which are hereby incorporated by reference.

### FIELD OF TECHNOLOGY

The following relates to a novel method for producing an electrical contact assembly and to an electrical contact assembly.

### BACKGROUND

In electrical installations, there are often particular requirements for electrical contacts, in particular the contacts that form a switching pole in switching elements. These requirements may be for example: a high conductivity, a specific hardness, a high resistance to burn-up in switching operations and/or a specific temperature resistance.

Suitable materials in this case often do not meet all the requirements equally well. For example, there are materials which have a high conductivity, but are relatively soft. Many materials that are well suited for contacting are not at the same time suitable for forming the element that mechanically carries the contact, and/or are comparatively expensive. Typical contact materials are in this case silver-based materials with a high silver content, such as for example silver graphite, in particular with graphite contents of 2 to 5 percent by weight (% by weight) and hardnesses of 35 to 60 HV 10.

It is usual to connect contact material supports formed from such contact materials to a carrier to form a contact assembly. It is known in this case to apply the contact material to the carrier by means of soldering or welding or to introduce it into an opening in the carrier as a contact rivet.

A disadvantage of the material-bonding production methods of soldering and welding is that, over the course of time and/or due to mechanical and/or thermal loading of the contact, delamination can occur in the connecting zone between the contact and the carrier, as a result of which the contact becomes unusable or unsafe. In particular in the latter case, there may be significantly increased electrical resistances in the contact region, which can result in undesirable heating up, even to the extent of causing fires.

A disadvantage of the contact rivets is that, likewise due to mechanical and/or thermal loading, settlements can occur within the riveted connection and result in the frictional and/or interlocking engagement of the riveted connection being lost, with the adverse effects described above.

### SUMMARY

An aspect relates to provide a novel method for producing an electrical contact assembly and also to provide a novel electrical contact assembly.

One advantage of embodiments of the present invention is that a connection comprising both material bonding and frictional or interlocking engagement, a connection comprising frictional and interlocking engagement, is produced between the contact and the contact carrier in one working step. Consequently, the method is only a little more complex than conventional methods, but produces a significantly more robust connection which, as compared with riveted connections, additionally comprises material bonding and, as compared with soldered or welded connections, additionally comprises interlocking and/or frictional engagement. In this way, embodiments of the present invention avoids the disadvantages mentioned at the beginning.

### BRIEF DESCRIPTION

Some of the embodiments will be described in detail, with reference to the following figures, wherein like designations denote like members, wherein:

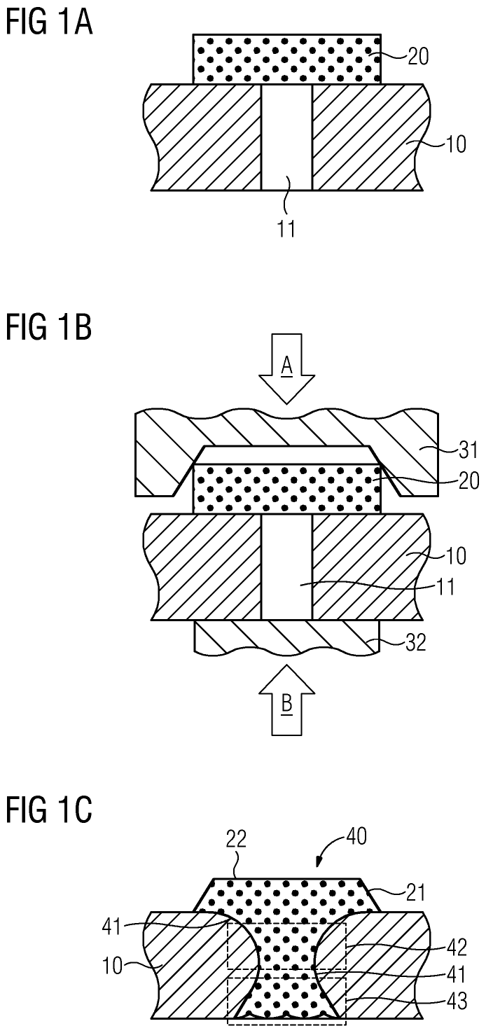

FIG. 1A shows a contact carrier and a contact material support intended for connection with the latter in a schematic representation;

FIG. 1B shows the beginning of the joining process between the contact carrier and the contact material support in a schematic representation; and

FIG. 1C shows the finished contact assembly.

### DETAILED DESCRIPTION

FIG. 1A shows a contact carrier 10 with a through-opening 11 in a schematic representation. In preparation, a contact material support 20 has already been placed onto this contact carrier.

At least in the region of the through-opening 11, the contact carrier 10 is suitable for material bonding and riveting, i.e., at least in this region it at least partially consists of a material or is at least partially coated with a material which can enter into a material bond with the material of the contact material support 20. Conversely, the contact material support 20 consists of a material which in the region of the joint can enter into a material bond with the (surface) material of the contact carrier 10.

Suitable materials for the contact material support 20 are for example silver graphite, in particular in the specific form of AgC4, and other silver- or copper-based materials, in exemplary embodiments comprising organic or inorganic constituents such as for example carbon C, tungsten W, tungsten carbide WC and/or tin oxide SnO2.

Suitable materials for the contact carrier 10 and/or its surface coating in the region of the joint with the contact material support are for example copper, brass or steel. If, for example for reasons of strength, the carrier consists of a material which cannot enter into a material bond with the material of the contact piece, chosen for example because of its electrical properties, or can only enter into a material bond with it to a slight extent, it is for example possible to use plating or a chemical process to apply to the carrier 10 a thin layer capable of material bonding. In this case, the thin layer may be confined to the region of the material bond 41 to be produced (see FIG. 1C), that is to say the interior of the opening 11 and other regions in contact with the contact body after joining.

FIG. 1B shows the beginning of the joining operation between the contact material support 20, forming the later contact piece, and the contact carrier 10 in a schematic representation. In the exemplary embodiment, a resistance welding device has a contact-piece-side electrode 31 and a carrier-side electrode 32. The contact-piece-side electrode 31 has a contact-piece-side shape, which corresponds substantially to the target shape of the contact piece 21 (see FIG. 1C). In the example represented, the shape is substantially frustoconical. A conventional resistance welding device with a suitably shaped electrode may be advantageously used in this case, i.e. a special machine is not required for this production method.

After aligning the workpieces 10, 20 and the electrodes 31, 32, so as to be concentric to the opening 11, a voltage is applied to the electrodes and a joining force is exerted, indicated by arrows A and B. The voltage, to be precise the variation in the voltage over time, is in this case chosen such that a current flowing through the contact material support 20 and the contact carrier 10 has a variation over time which, together with the variation over time of the forces A and/or B, makes possible a material-bonding connection of the contact 21 (FIG. 1C) created, in particular with the inner surfaces of the opening 11 of the contact carrier 10.

In this case, the voltage or the current may for example be chosen at first to be high, in order to bring the contact material support 20 and the joining region of the contact carrier 10 from the solid state to a deformable state by heating. In this case, the material does not have to be heated up to the melting point, it is sufficient if deformation without tearing is made possible under the effect of force. In this state, the contact material support 20 is pressed by the effect of force A, B to form the contact 21 in the opening 10. Subsequently or during this operation, the process parameters, such as for example the current intensity and its variation over time and also the forces A and/or B and their variation over time, may be chosen such that in the contact region 41 welding is brought about between the contact material support 20 or the contact 21 and the opening 10, i.e. a material-bonding unification of the contact 21 and the carrier 10 is brought about in the region of the areas where they touch.

The result of this operation is shown in FIG. 1C. The contact material support 20 has been re-shaped into a contact 21 with a contact area 22, which is connected to the carrier 10. The connection created in this case comprises material bonding and additionally interlocking and/or frictional engagement along the areas where the contact 21 and carrier 10 touch. In the example represented, the connection has both a predominantly interlockingly engaging region 42 and a predominantly frictionally engaging region 43. As shown in the exemplary embodiment represented, a particularly robust connection can be achieved if the production process and its parameters, in particular for example the variation in the current over time and the variation in the force over time, are chosen such that the carrier material also becomes deformable in the region of the joint and the forming of a kind of rivet head of the contact 21 is made possible in the region 43.

For the forming of this rivet head, or in more general terms a widening of the contact material in the region 43, it may be sufficient to utilize the properties of the carrier 10. Specifically, when the carrier is heated up by the flowing current, these properties bring about a softening of the carrier material from the outside to the core and, together with the effect of force A, B, consequently promote the forming of the shape represented in FIG. 1C, which is distinguished by the fact that the deformation of the carrier is greater at the respective surfaces than in the core (approximately corresponding to the region 42) of the carrier.

The forming of the widening of the contact 21 in the region 43 can be promoted by the aperture being provided with a larger cross section on the side of the carrier 10 that is facing away from the contact area 22 than on the side that is facing the contact area 22.

In other exemplary embodiments, it may be sufficient for there to be a connection comprising material bonding and predominantly interlocking engagement, without the material of the carrier 10 being appreciably deformed in the region of the joint.

In further exemplary embodiments of the present invention, two contact material supports may be provided (not represented), a second contact material support being placed into or onto the electrode 32 on the side of the carrier facing away from the first contact material support before the beginning of the joining process. In this way, a two-sided contact can also be produced for example, by the lower electrode 32 being designed by analogy with the electrode 31 and by the contact material supports (which are generally softer than the carrier material) being welded or fused to one another in the opening 11 during the joining process.

In exemplary embodiments of the present invention, the opening 11 may be a through-opening, for example be formed cylindrically, or have other contours, for example as an elongated hole or oval or droplet-shaped. In other exemplary embodiments, the opening 11 is a depression, i.e. for example a blind hole, with one of the aforementioned contours or cross sections.

In this case it is possible to connect a correspondingly larger contact to the carrier by means of two or more openings or depressions.

It should finally be pointed out that the exemplary embodiments described above can be combined with one another as desired.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A method for producing an electrical contact assembly with the following steps:
a) providing a contact carrier of a first conductive material, the contact carrier having at least one depression or an aperture;
b) providing a contact material support of a second conductive material;
c) pressing the contact material support in the depression or the aperture while at the same time applying an electrical welding voltage to the contact material support and the contact carrier, a pressing-force/welding-current/time profile being chosen such that the contact carrier and the contact material support form a connection comprising interlocking and/or frictional engagement and a connection comprising material bonding in one working step.

2. The method as claimed in claim 1, in which the depression of the contact carrier is a blind hole with a circular or oval cross section.

3. The method as claimed in claim 1, in which the aperture in the contact carrier is cylindrical or an elongated hole or an oval aperture or an aperture of a droplet shape.

4. The method as claimed in claim 1, in which the second conductive material comprises one or more of the following constituents: copper, silver, organic or inorganic constituents.

5. The method as claimed in claim 4, in which at least one organic or inorganic constituent is chosen from the group comprising: carbon C, tungsten W, tungsten carbide WC, tin oxide SnO2.

6. The method as claimed in claim 1, in which the first conductive material comprises one or more of the following constituents: copper, brass, steel.

7. The method as claimed in claim 1, in which the copper carrier consisting of the first conductive material is provided with a layer which makes possible or improves the forming of the material-bonding connection to the contact material support.

8. The method as claimed in claim 1, in which the pressing-force/welding-current/time profile is chosen such that heating up of the contact carrier by the flowing current brings about a deformability of the contact carrier in the surface region, so that the deformation of the contact carrier by the effect of a pressing force when the contact material support is pressed into the contact carrier is greater at the surfaces of the contact carrier than in a core region of the contact carrier, and a greater displacement of the first conductive material by the second conductive material is brought about in the region of the surfaces of the contact carrier.

9. An electrical contact assembly having a contact carrier of a first conductive material and also a contact piece of a second conductive material, the contact piece and the contact carrier being connected by the method according to claim 1 so as to comprise interlocking and/or frictional engagement and also material bonding.
